(19) United States
(12) Patent Application Publication
(10) Pub. No.: US 2003/0109159 A1
(43) Pub. Date: Jun. 12, 2003

(54) Insertion detection switch, connection apparatus and connector apparatus

(76) Inventors: Atsushi Nishio, Mito-Shi (JP); Takashi Kawasaki, Mito-Shi (JP); Kazuhiro Okazaki, Mito-Shi (JP); Satoru Karahashi, Mito-Shi (JP)

Correspondence Address: LADAS & PARRY, 224 SOUTH MICHIGAN AVENUE, SUITE 1200, CHICAGO, IL, 60604, US

(21) Appl. No.: 10/314,505

(22) Filed: Dec. 9, 2002

(30) Foreign Application Priority Data
Dec. 11, 2001 (JP) 2001-377807
Dec. 11, 2001 (JP) 2001-377808
Dec. 11, 2001 (JP) 2001-377809

(51) Int. Cl. H01R 29/00

(52) U.S. Cl. 439/188

(57) ABSTRACT

An insertion detection switch is provided for detecting that a recording medium on which electrode pads are formed is inserted. The insertion detection switch has a first contact and a second contact that are electro-independently arranged on an insertion trajectory of one of the electrode pads of the recording medium. The first contact and the second contact are electrically connected via one of electrode pads when the recording medium is inserted to a predetermined installation position.

### BACKGROUND OF THE INVENTION

1. Field of the Invention

The present invention generally relates to an insertion detection switch, a connection apparatus and a connector apparatus, and more particularly to an insertion detection switch to detect a recording medium on which electrodes are constructed, a connector apparatus in which a slider having a connector with which the recording medium is connected moves in a chassis and a connection apparatus that connects a plurality of different shapes of connection parts.

2. Description of the Related Art

FIG. 1 through FIG. 3 show a connector apparatus 1 that is an example of a conventional connector apparatus. FIG. 1 through FIG. 3 also show the connector apparatus 1 in which an example of a conventional connection apparatus is applied.

The connector apparatus 1 is provided in a personal computer (PC) and connects a recording medium 2, such as an IC card or a memory card, with the PC. FIG. 1 shows the connector apparatus 1 in which the recording medium 2 is mounted and FIG. 2 shows the connector apparatus 1 in which the recording medium 2 is ejected.

The connector apparatus 1 mainly has a chassis 3, a slider 4, a front bezel 5, and so on. The slider 4 further constructs a connection apparatus.

A metal plate is folded and formed into the chassis 3. The chassis 3 has a base plate 6 and side plates 7 at both sides of the chassis 3 and a top plate 8 that is folded inside. The slider 4 is placed in a space which is surrounded by the base plate 6, the side plates 7 and the top plate 8.

The slider 4 is provided on the chassis 3 and can move in the directions of X1 and X2. This slider 4 mainly has a medium connector 15, an FPC connector 16 and wiring board 18, and so on. FIG. 4 shows an enlarged figure of the connector apparatus 1 and as shown in FIG. 4, the medium connector 15 and the FPC connector 16 are provided on the wiring board 18.

The medium connector 15 is a connector in which the recording medium 2 is inserted. Medium connection contacts 21 that are electrically connected to the recording medium 2 are provided in the medium connector 15. The FPC connector 16 is a connector in which a FPC (flexible printed board) 17 connected to the PC is inserted and FPC connection contacts 22 that are electrically connected to the FPC 17 are provided in the FPC connector 16.

The medium connection contacts 21 and the FPC connection contacts 22 are electrically connected through the wiring board 18 and therefore, the recording medium 2 is electrically connected to the PC through the slider 4 and the FPC 17. The FPC connector 16 is placed on an extended part 19 that is extendedly formed at the end of the wiring board 18 in the direction of X1.

As described above, the slider 4 can move in the directions X1 and X2 within the chassis 3. The slider 4 is moved by means of the insertion operation for the recording medium 2 and by means of the eject operation for the recording medium 2 using an eject mechanism provided on the chassis 3.

FIG. 2 shows the connector apparatus 1 in which the slider 4 is at the eject position (the slider 4 is moved in the direction of X2). While the slider 4 is at the eject position, the recording medium 4 can be mounted on the slider 4 or can be removed from the slider 4. More specifically, the recording medium 2 is inserted to the slider 4 at the eject position through an insertion opening of the front bezel 5.

The recording medium 2 is mounted on the slider 4 at the eject position through the insertion opening of the front bezel 5. A medium insertion detection switch 20 detects whether the recording medium 2 is firmly mounted on the slider 4 or not.

Further, as shown in FIG. 2, the recording medium 2 extends by a predetermined length from the front bezel 5 in the direction of X2 when the recording medium 2 is mounted on the slider 4. An operator pushes the part of the recording medium 2 that extends from the front bezel 5 in the direction X1.

When the recording medium 2 is pushed, the slider 4 with the recording medium 2 moves in the direction of X1 in the chassis 3 and reaches a predetermined installation position shown in FIG. 1. A slider insertion detection switch 14 provided on a switch attachment part 13 of the chassis 3 detects that the slider 4 reaches the predetermined installation position. When the slider 4 reaches the predetermined installation position in the chassis 3, an eject button 10 of the eject mechanism is extended from the front bezel 5.

In order to eject the recording medium 2 from the connector apparatus 1, the eject button 10 is pushed in the direction of X1. Then, an eject arm 11 and an eject lever 12 of the eject mechanism are actuated and the slider is moved in the direction of X2. As a result, the slider 4 again returns to the eject position as shown in FIG. 2.

The medium insertion detection switch 20 detects whether the recording medium 2 is firmly mounted on the slider 4 or not. FIG. 4 and FIG. 5 show an insertion detection method using the medium insertion detection switch 20 in which it is detected whether the recording medium 2 is mounted on the slider 4 or not.

The medium insertion detection switch 20 mainly has the first contact 23 and the second contact 24 and is provided in the medium connector 15 which constructs the slider 4. The position of the medium insertion detection switch 20 is a position at which the medium insertion detection switch 20 engages the case of the recording medium 2. When the recording medium 2 is inserted to the predetermined position, the first contact 23 is connected to the second contact 24, and thereby the insertion of the recording medium 2 to the predetermined installation position is detected. The predetermined installation position is a position where the electrode pads formed on the recording medium 2 are firmly and electrically connected to the contacts on the medium connector 15.

The insertion detection method for the recording medium 2 detects that the recording medium 2 is inserted to the predetermined installation position, on a basis of the case of the recording medium 2. Therefore, accuracy of formation of the case of the recording medium 2 directly affects the accuracy of the insertion detection of the recording medium 2. However, the accuracy of formation of the case of the recording medium 2 is low and the outside dimensions of the case greatly fluctuate. Therefore, the result of the insertion detection of the recording medium 2 is uncertain when the conventional insertion detection method is used. As a result, it is not possible to reliably perform a high precision insertion detection of the recording medium 2.

It is a general object of the present invention to provide an insertion detection switch and a connector apparatus in which a high precision insertion detection of the recording medium can be reliably performed.

Further, in the conventional connector apparatus 1 as described above, the slider insertion detection switch 14 provided on the switch attachment part 13 of the chassis 3 is used to detect that the slider 4 reaches the predetermined installation position. A detection knob 14a of the slider insertion detection switch 14 is pushed when the slider 4 is moved to the predetermined installation position, and thereby it is detected that the slider 4 reaches the predetermined installation position.

However, in this construction, the switch attachment part 13 needs to be formed on the chassis 3 and the discrete slider insertion detection switch 14 as well as the chassis 3 and the slider 4 are further needed. Therefore, the number of the parts is increased and the assembly operation becomes complex, and as a result, the cost of the connector apparatus 1 becomes high. Furthermore, the outside dimensions of the connector apparatus 1 become large because the switch attachment part 13, which extends from the chassis 3 in the direction of X1, needs to be formed on the chassis 3.

It is a general object of the present invention to provide a connector apparatus in which the number of the parts is decreased and the cost of the connector apparatus is reduced.

Furthermore, the medium connector 15 and the FPC connector 16 are separately formed on the conventional slider 4 and the connectors 15 and 16 are separately attached to the wiring board 18.

Housings of the connectors 15 and 16 are formed by resin. However, two kinds of metal molds, one for forming the housing of the medium connector 15 and another for forming the housing of the FPC connector 16, are required when the connectors are manufactured because the connectors 15 and 16 are discrete. As a result, the cost for manufacturing the connectors becomes high. Furthermore, the number of the parts is increased, and thereby the cost becomes high.

Furthermore, the connectors 15 and 16 are attached to the wiring board 18 in separate steps, and thereby the assembly operation of the slider 4 becomes complex.

It is a general object of the present invention to provide a connection apparatus and a connector apparatus in which the number of parts is decreased and the cost is also reduced.

### SUMMARY OF THE INVENTION

It is a general object of the present invention to provide an insertion detection switch, a connection apparatus and a connector apparatus in which the above disadvantages are eliminated.

According to the invention described in claim 1, the above objects of the present invention are achieved by an insertion detection switch for detecting that a recording medium on which electrode pads are formed is inserted, comprising:

a first contact and a second contact that are electro-independently arranged on an insertion trajectory of one of the electrode pads of said recording medium, wherein the first contact and the second contact are electrically connected via one of electrode pads when the recording medium is inserted to a predetermined installation position.

According to the insertion detection switch of the present invention, the first contact and the second contact are connected via one of electrode pads when the recording medium is inserted to the predetermined installation position. Then, it can be detected that recording medium is inserted to the predetermined installation position by means of detecting the electrical connection between the first contact and the second contact via one of electrode pads.

Because the dimensional accuracy of the electrode pad is higher than the dimensional accuracy of the case of the recording medium, the insertion position of the recording medium can be more accurately detected based on the position of the electrode pad than based on the outline of the case of the recording medium.

According to the invention described in claim 2, the above objects of the present invention are achieved by a connector apparatus having the insertion detection switch as claimed in claim 1.

According to the connector apparatus of the present invention, the connector apparatus that can correctly detect the insertion of the recording medium is achieved.

According to the invention described in claim 3, the above objects of the present invention are achieved by the connector apparatus as claimed in claim 2, wherein at least one of the first contact and the second contact is used for a signal terminal.

According to the connector apparatus of the present invention, it is not needed to provide the electrode pads for only detecting the insertion position of the recording medium because at least one of the first contact and the second contact can also be used as the signal terminal. As a result, it can be achieved to reduce the size of the connector apparatus and the recording medium.

According to the invention described in claim 4, the above objects of the present invention are achieved by a connector apparatus comprising:

a first member in which a recording medium is inserted and that has a connector to which the recording medium is connected;

a second member that movably holds the first member which first member moves to a predetermined installation position after insertion of the recording medium to the first member; and

a detection switch that detects a time when the first member reaches the predetermined installation position,

wherein the detection switch comprises:

a switch mechanism that is formed on the first member; and

an engagement part that is formed on the second member as a monoblock, engages the switch mechanism when the first member reaches the predetermined installation position and operates the switch mechanism.

According to the connector apparatus of the present invention, it is possible to reduce the number of the parts and to simplify the assembly operation compared to the case in which the discrete switch is provided because the switch mechanism is formed on the first member and the engagement part is formed on the second member as a monoblock and operates the switch mechanism.

According to the invention described in claim 5, the above objects of the present invention are achieved by the connector apparatus as claimed in claim 4, wherein the switch mechanism comprises:

a first contact that is formed on the first member; and

a second contact that is formed on the first member opposite to the first contact; wherein the first contact engages the engagement part and is displaced when the first member reaches the predetermined installation position, and the first contact is electrically connected with the second contact.

According to the connector apparatus of the present invention, it is possible to detect the position of the recording medium using a simple construction because the switch mechanism is constructed by the first contact and a second contact, and the position detection process is performed by means of the displacement of the second contact that engages the engagement part.

According to the invention described in claim 6, the above objects of the present invention are achieved by a connection apparatus comprising:

a first connector part with which a first connection member having a first shape is connected;

a second connector part with which a second connection member having a second shape different from the first shape of the first connection member is connected; and

a mold member that is molded to have the first connector part and the second connector part as a monoblock.

According to the connection apparatus of the present invention, the number of the parts is reduced and the cost is also reduced compared to the case wherein the first connector part and the second connector part are formed discretely because the first connector part and the second connector part are molded in the mold member as a monoblock.

According to the invention described in claim 7, the above objects of the present invention are achieved by the connection apparatus as claimed in claim 6, wherein the mold member is formed to have a flat shape, and a first opening into which the first connection member is inserted is formed at one side of the mold member and a second opening into which the second connection member is inserted is formed at another side of the mold member.

According to the connection apparatus of the present invention, it is possible to achieve the connection apparatus having a low height if the two connector parts are formed as a monoblock because the mold member is formed to have a flat shape, and the first opening into which the first connection member is inserted and the second opening into which the second connection member is inserted are formed at different sides of the mold member.

According to the invention described in claims 8 and 9, the above objects of the present invention are achieved by the connection apparatus as claimed in claim 6 or claim 7, wherein the first connection member having the first shape is a recording medium and the second connection member having the second shape different from the first shape of the first connection member is a flexible flat cable.

According to the invention described in claims 10 to 13, the above objects of the present invention are achieved by a connector apparatus comprising the connection apparatus as claimed in any one of claims 6 to 9.

### BRIEF DESCRIPTION OF THE DRAWINGS

Other objects, features and advantages of the present invention will become more apparent from the following detailed description when read in conjunction with the accompanying drawings, in which:

FIG. 1 shows the connector apparatus in which the recording medium is mounted according to the prior art;

FIG. 2 shows the connector apparatus in which the recording medium is ejected according to the prior art;

FIG. 3 is a sectional diagram of the slider shown in FIG. 1 and FIG. 2 according to the prior art;

FIG. 4 shows an operation of the medium insertion detection switch according to the prior art;

FIG. 5 shows an operation of the medium insertion detection switch according to the prior art;

FIG. 6A is a top view of the connector apparatus according to the embodiment of the present invention;

FIG. 6B is a left side view of the connector apparatus according to the embodiment of the present invention;

FIG. 6C is a bottom view of the connector apparatus according to the embodiment of the present invention;

FIG. 6D is a front view of the connector apparatus according to the embodiment of the present invention;

FIG. 7A is an enlarged top view of the slider according to the embodiment of the present invention;

FIG. 7B is an enlarged left side view of the slider according to the embodiment of the present invention;

FIG. 7C is an enlarged sectional view of the slider according to the embodiment of the present invention;

FIG. 8 shows an operation (1) of the slider insertion detection switch according to the embodiment of the present invention;

FIG. 9 shows an operation (2) of the slider insertion detection switch according to the embodiment of the present invention;

FIG. 10 shows an operation (1) of the medium insertion detection switch according to the embodiment of the present invention;

FIG. 11 is shows an operation (2) of the medium insertion detection switch according to the embodiment of the present invention;

FIG. 12 shows an operation (3) of the medium insertion detection switch according to the embodiment of the present invention; and

FIG. 13 shows an operation (4) of the medium insertion detection switch according to the embodiment of the present invention.

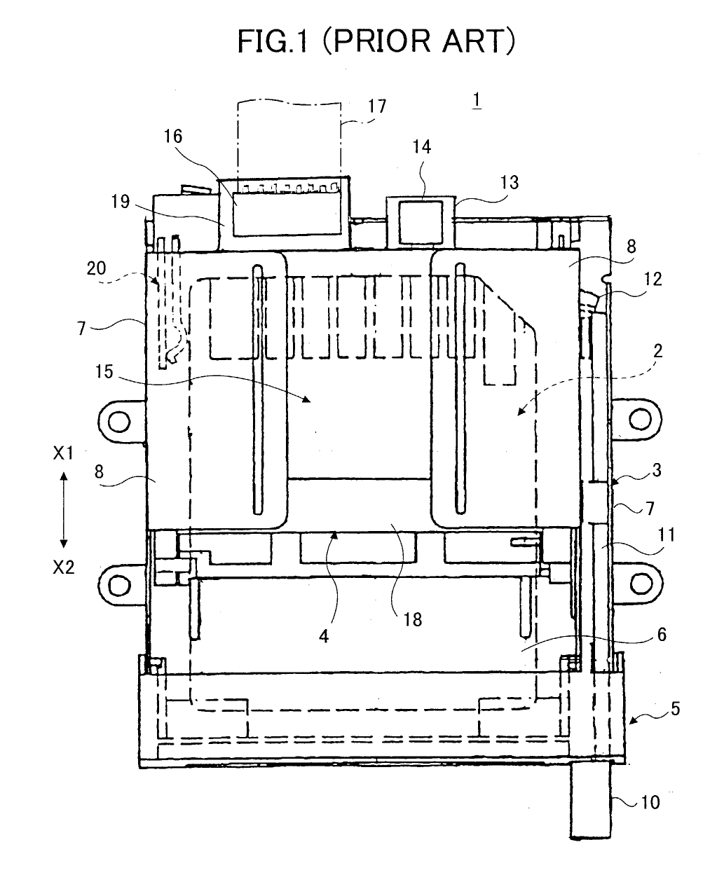

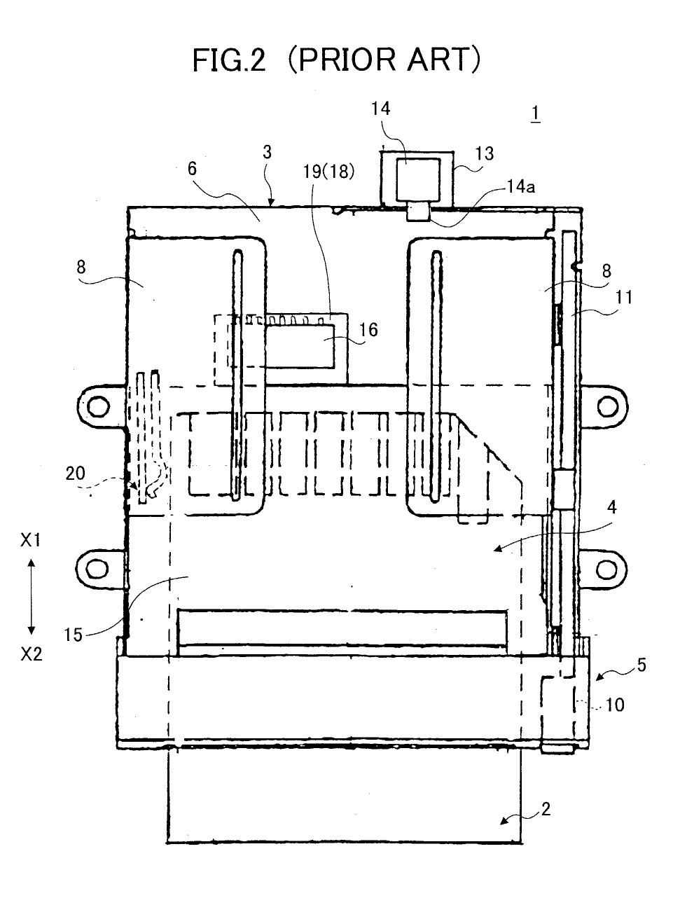

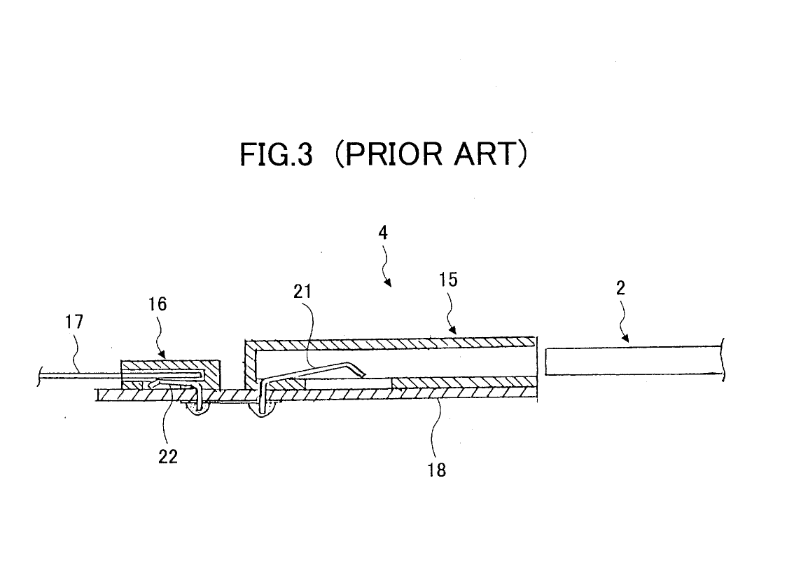

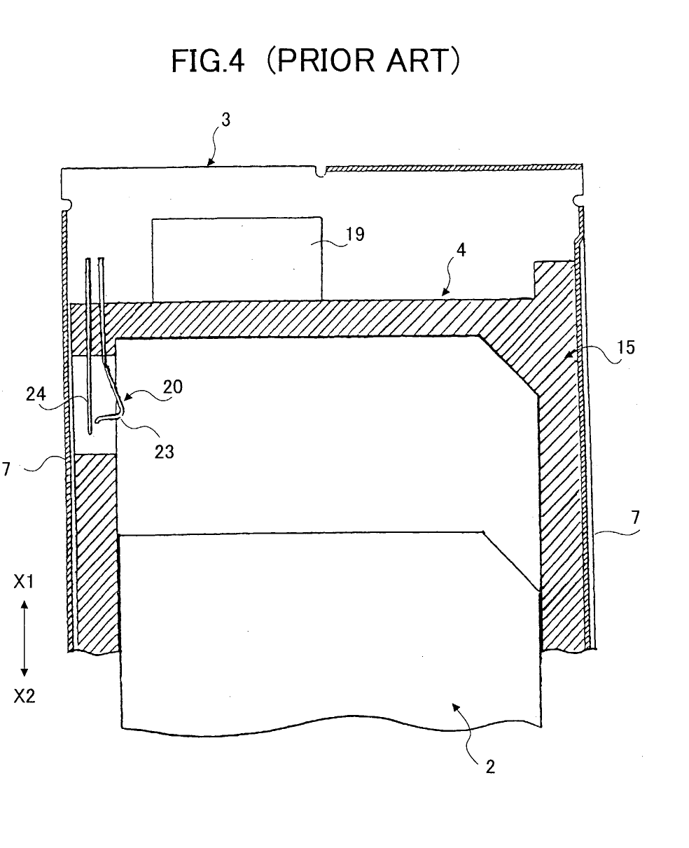

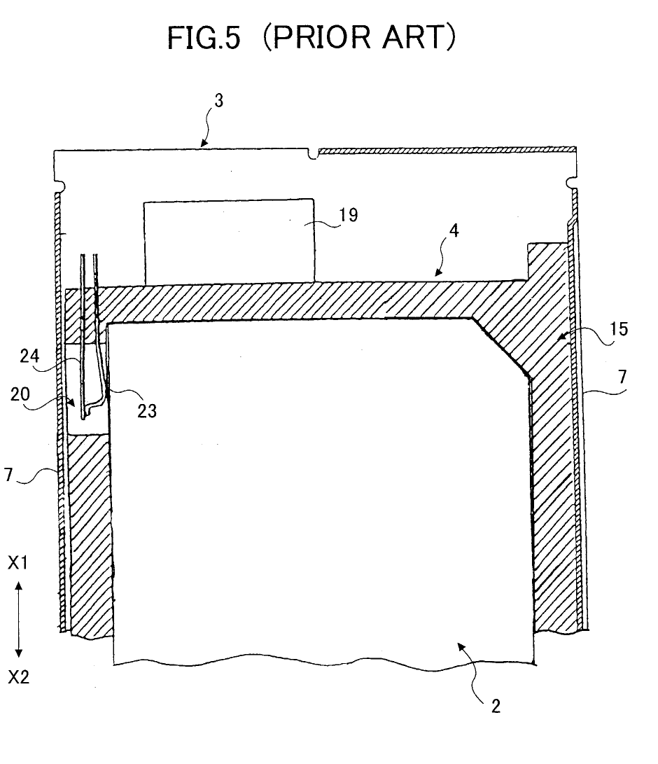

### DESCRIPTION OF THE PREFERRED EMBODIMENTS

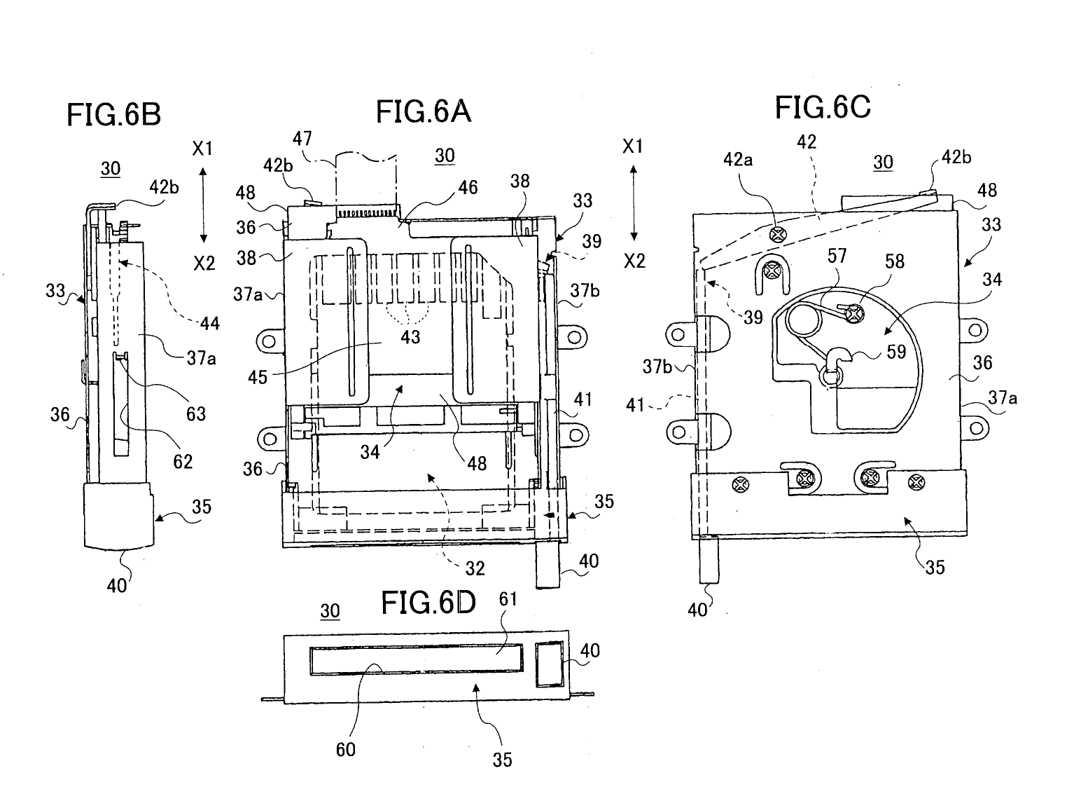

FIGS. 6A, 6B, 6C and 6D show a connector apparatus 30 according to the embodiment of the present invention. FIG. 6A is a top view of the connector apparatus according to the embodiment of the present invention. FIG. 6B is a left side view of the connector apparatus 30 according to the embodiment of the present invention. FIG. 6C is a bottom view of the connector apparatus 30 according to the embodiment of the present invention. FIG. 6D is a front view of the connector apparatus 30 according to the embodiment of the present invention. The connector apparatus 30 is provided in a personal computer (PC) and connects a recording medium 32, such as an IC card or a memory card, with the PC. FIGS. 6A, 6B, 6C and 6D show the connector apparatus 30 in which the recording medium 32 is mounted.

The connector apparatus 30 mainly has a chassis 33, a slider 34, a front bezel 35, and so on.

A metal plate is folded and formed into the chassis 33. The chassis 33 has a base plate 36 and side plates 37a and 37b formed at both sides of the chassis 33 and a pair of top plates 38 that are formed by means of folding the side plates 37a and 37b inside. The slider 34 is provided in a space which is surrounded by the base plate 36, the side plates 37 and the top plates 38.

An eject mechanism 39 is provided on the chassis 33. As described below, the slider 34 can move in the directions of X1 and X2 within the chassis 33. The eject mechanism 39 moves the slider 34 from a predetermined installation position shown in FIGS. 6A, 6B, 6C and 6D to an eject position (at which the recording medium 32 can be mounted on the slider 34 or removed from the slider 34).

The eject mechanism 39 mainly has an eject button 40, an eject arm 41, an eject lever 42, a torsion spring 57, and so on. The eject button 40 is attached to the end of the eject arm 41 in the direction of X2 as a monoblock. As shown in FIGS. 6A, 6B, 6C and 6D, the eject button 40 extends from the front bezel 35 in the direction of X2 when the slider 34 is at the predetermined installation position.

The front bezel 35 is formed by resin and attached at the end of the chassis 33 in the direction of X2. The front bezel 35 has a medium insertion opening 60 through which the recording medium 32 is inserted and a lid 61 that covers the medium insertion opening 60.

The eject arm 41 to which the eject button 40 is attached can move in the directions X1 and X2 within the chassis 33. The end of the eject arm 41 in the direction of X1 engages one end of the eject lever 42. The eject lever 42 can rotate around the axis 42a placed in the chassis 33. Another end of the eject lever 42 is formed a lever part 42b that engages the slider 34.

Therefore, when the eject button 40 is pushed in the direction of X1, the eject arm 41 moves in the direction of X1. When the eject arm 41 moves, the eject lever 42 rotates around the axis 42a clockwise in FIG. 6C. As the eject lever 42 rotates, the lever part 42b pushes and moves the slider 34 in the direction of X2, and thereby the slider 34 moves in the direction of X2 (the eject direction).

One end of the torsion spring 57 is movably attached to an attachment 59 on the chassis 33 and another end of the torsion spring 57 is fixed to a screw 58. The torsion spring 57 exerts an elastic force so that the ends of the torsion spring 57 are forced apart.

As shown in FIGS. 6A, 6B, 6C and 6D, when the slider 34 is placed at the predetermined installation position as shown in FIG. 6C, the position of the screw 58 of the slider 34 is placed in the direction of X1 relative to the attachment part 59 of the chassis 33. Therefore, the elastic force generated by the torsion spring 57 acts on the slider 34 so that the slider 34 has a force applied in the direction of X1.

On the other hand, when the eject button 40 is pushed and the slider 34 is moved in the direction of X2 and the screw 58 is moved to the direction of X2 and the screw 58 is moved to the side of X2 relative to the attachment part 59, the elastic force generated by the torsion spring 57 acts on the slider 34 so that the slider 34 is reversed and a force is applied in the direction of X2.

As a result, if the eject button 40 is actuated so that the screw 58 is moved to the position at the side of X2 relative to the attachment part 59, the slider 34 is automatically moved toward the eject position by the elastic force of the torsion spring 57. Therefore, the operability on the ejection will be enhanced because the distance that the eject button 40 must be moved by being pushed can be reduced.

When the slider 34 is moved to the predetermined installation position, the torsion spring 57 performs a converse action. That is to say, when the operator inserts the recording medium 32 mounted on the slider 34 in the direction of X1, the operator pushes the slider so that the screw 58 is moved to the side of X1 relative to the attachment part 59. Then, the slider 34 is automatically moved toward the predetermined installation position by the elastic force generated by the torsion spring 57. As a result, the operability will be enhanced when the recording medium 32 is inserted.

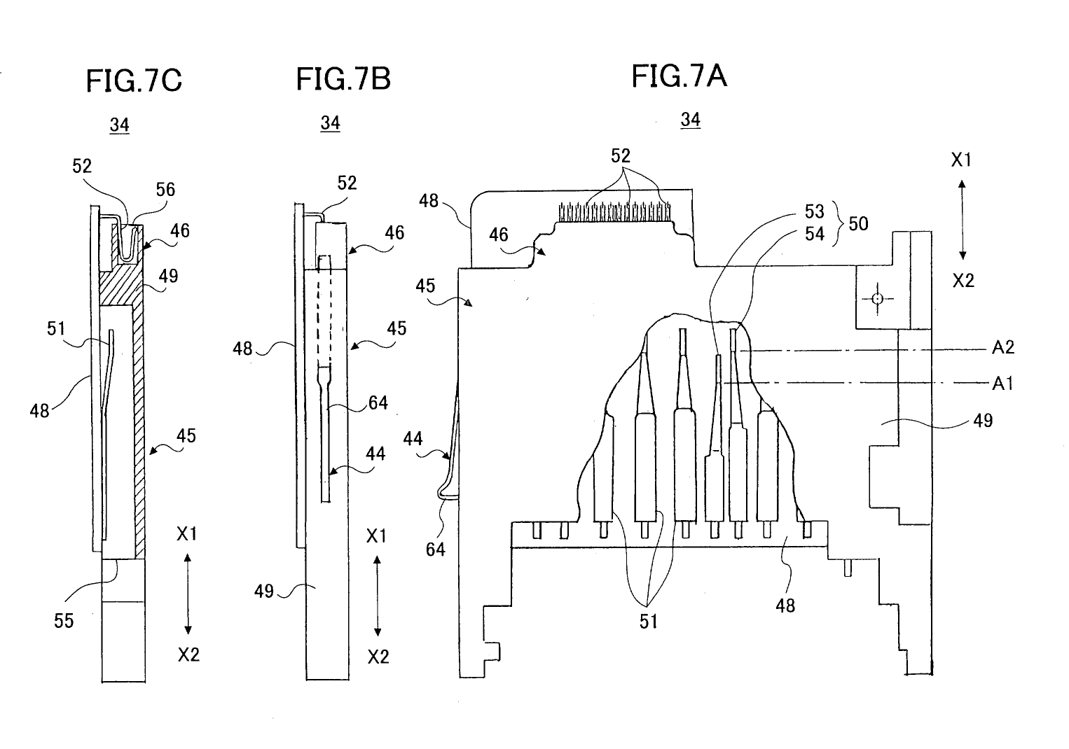

Next, the slider 34 will be explained. FIGS. 7A, 7B and 7C show enlarged figures of the slider 34 according to the embodiment of the present invention. FIG. 7A is an enlarged top view of a part of the slider 34 according to the embodiment of the present invention. FIG. 7B is an enlarged left side view of the slider 34 according to the embodiment of the present invention. FIG. 7C is an enlarged sectional view of the slider according to the embodiment of the present invention.

The slider 34 is provided on the chassis 33 and can move in the directions of X1 and X2. The slider 34 mainly has a slider insertion detection switch 44, a medium connector part 45, an FPC connector part 46, a wiring board 48, a medium insertion detection switch 50, and so on.

The medium connector part 45 is a connector in which the recording medium 32 is inserted. Medium connection contacts 51 that are electrically connected to the recording medium 32 are provided in the medium connector part 45. The medium insertion detection switch 50 is also placed in the medium connector part 45 as well as the medium connection contacts 51.

The medium connection contacts 51 and the medium insertion detection switch 50 are provided on the wiring board 48. Each point of the medium connection contacts 51 and the medium insertion detection switch 50 is deformed so that each point of the medium connection contacts 51 and the medium insertion detection switch 50 is apart from the wiring board 48 as shown in FIG. 7C.

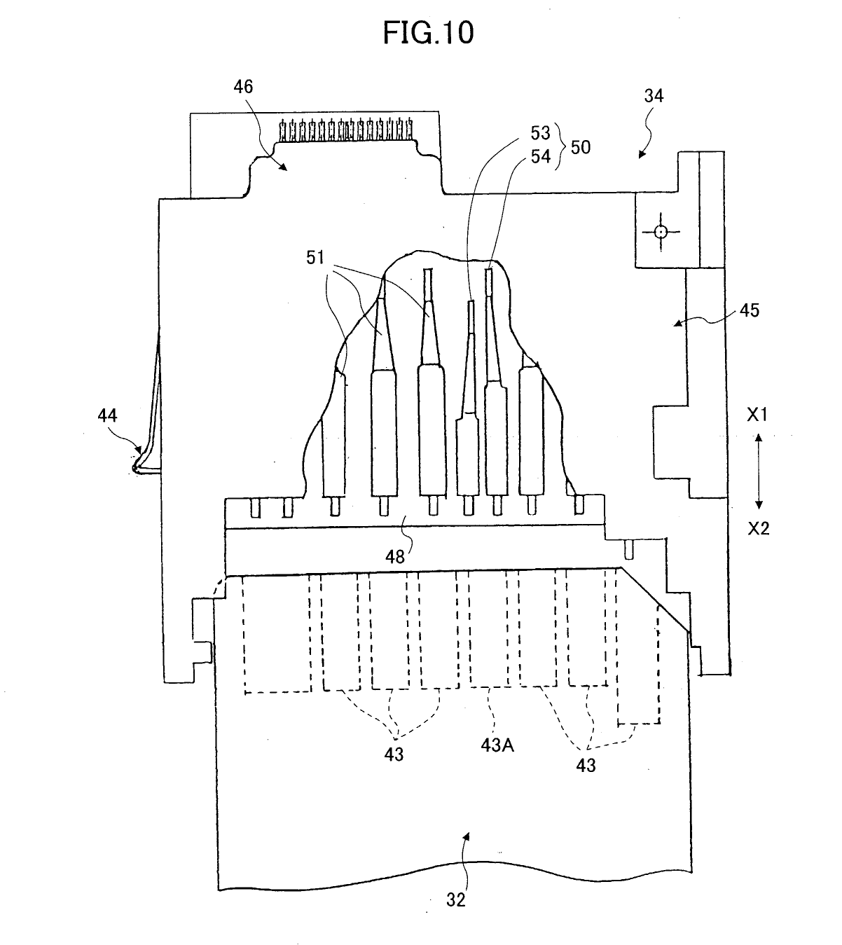

As shown in FIG. 10, electrode pads 43 are provided at the back side of the recording medium 32 (which surface of the recording medium 32 is opposite to the wiring board 48). Therefore, when the recording medium 32 is mounted on the slider 34, the medium connection contacts 51 and the medium insertion detection switch 50 contact with the electrode pads 43 of the recording medium 32 and are electrically connected to each other.

The medium insertion detection switch 50 has the first contact 53 and the second contact 54. The first contact 53 and the second contact 54 are connected to one of the electrode pads 43 formed on the recording medium 32 (especially, the electrode pad 43 that is connected to the medium insertion detection switch 50 and is labeled electrode pad 43A). The medium insertion detection switch 50 is a switch that detects that the recording medium 32 is attached to the slider 34. After the recording medium 32 is attached to the slider 34, the medium insertion detection switch 50 can act as other medium connection contacts 51. However, this operation will be described later.

The operation of the slider 34 will be explained with reference to FIGS. 7A through 7C. The FPC connector part 46 is a connector in which the FPC (flexible printed board) 47 is inserted. Therefore, the FPC connection contacts 52 that are electrically connected to the FPC 47 are provided in the FPC connector 46.

The medium connection contacts 51 (in which the medium insertion detection switch 50 is included) and the FPC connection contacts 52 are electrically connected through the wiring board 48. Therefore, the recording medium 32 is electrically connected to the PC through the slider 34 and the FPC 47 when the recording medium 32 is mounted on the slider 34.

The housing 49 of the medium connector part 45 and the FPC connector part 46 are shown in FIG. 7C.

As described above, the medium connector part 45 and the FPC connector part 46 having different shapes are formed on the slider 34, so that the recording medium 32 and the FPC 47 are connected to each other on the slider 34. In this embodiment, as shown in FIG. 7C, it is a characteristic (point of novelty) that the housing 49 of the medium connector part 45 and the FPC connector part 46 in which the parts having different shapes (the recording medium 32 and the FPC 47) are inserted is formed as a monoblock.

This construction enables the housing 49 of the medium connector part 45 and the housing 49 of the FPC connector part 46 to be molded as a monoblock. As a result, the number of parts is reduced and the cost is also reduced compared to the case where the medium connector part 45 and the FPC connector part 46 are formed discretely. Furthermore, it is possible to simplify the assembly operation to attach the medium connector part 45 and the FPC connector part 46 to the wiring board 48 and thereby the cost can be further reduced.

In this embodiment, the housing 49 of the medium connector part 45 and the FPC connector part 46 has a flat shape. An opening of a medium insertion part 55 of the medium connector part 45 to which the recording medium 32 is inserted and an opening of the FPC connection contacts 52 of the FPC connector part 46 to which the FPC 47 is connected are formed at opposite sides of the housing 49. Furthermore, the height of the medium connector part 45 from the surface of the wiring board 48 is approximately the same as the height of the FPC connector part 46.

This construction achieves the slider 34 having a low height because it is possible to keep the height of the housing 49 from the surface of the wiring board 48 low when the medium connector part 45 and the FPC connector part 46 are formed as the monoblock housing 49.

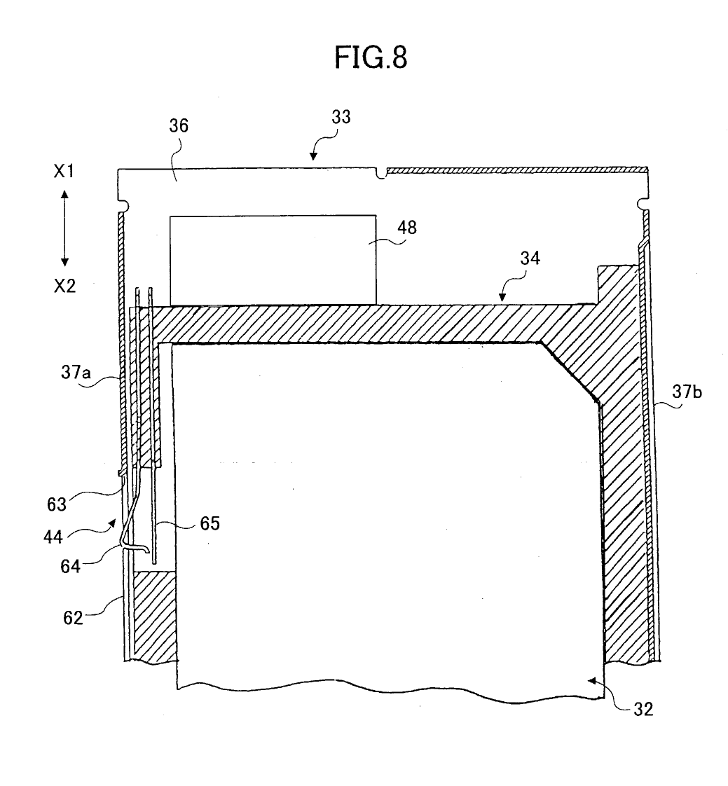

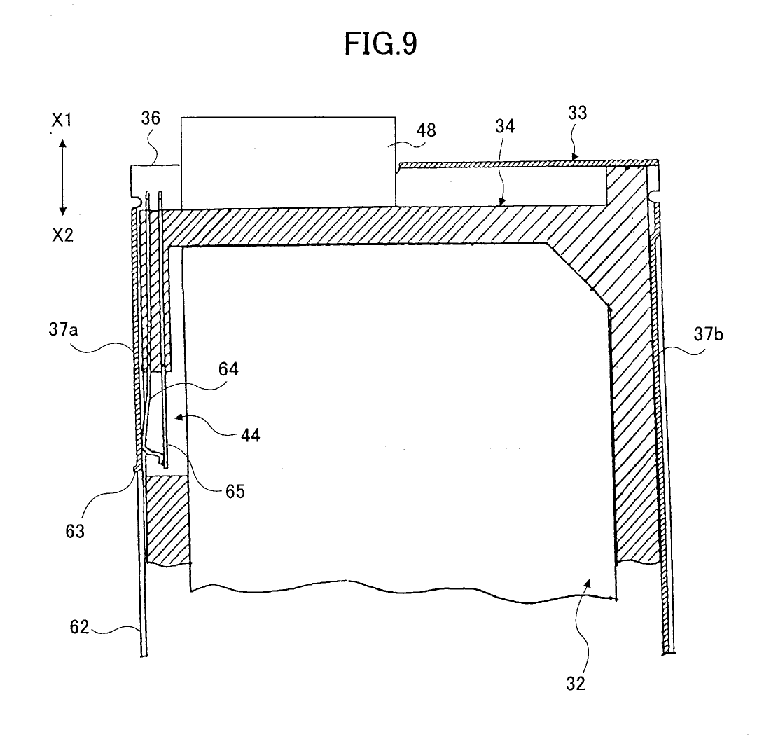

Next, the slider insertion detection switch 44 that is provided on the slider 34 will be explained using FIG. 8 and FIG. 9. The slider insertion detection switch 44 detects that the slider 34 is inserted to the predetermined installation position within the chassis 33.

FIG. 8 and FIG. 9 show the slider 34 mounted in the chassis 33. FIG. 8 shows that the slider 34 is placed at the position shifted to the direction of X2 from the predetermined installation position. FIG. 9 shows that the slider 34 is placed just at the predetermined installation position. In FIG. 8 and FIG. 9, the sectional view of the slider 34 in the horizontal direction is shown. In FIG. 8 and FIG. 9, the FPC connector part 46 is omitted for the convenience of explanation.

The slider insertion detection switch 44 mainly has the first contact 64, the second contact 65 and an engagement part 63. The first contact 64 and the second contact 65 are provided in the housing 49 of the slider 34. The first contact 64 and the second contact 65 are contact members that are composed of plated conductive metal material (that is commonly used for connector contacts).

Each of the contacts 64 and 65 has elasticity and therefore can be elastically deformed. The first contact 64 is formed to have a shape that is extended outside toward the side plate 37a of the chassis 33 (that is to say in the left direction as shown in FIG. 8). Furthermore, the contacts 64 and 65 are electrically separated from each other in normal condition (in which the first contact 64 is not in contact with the side plate 37a).

On the other hand, the engagement part 63 is formed on the chassis 33. Specifically, as shown in FIG. 6B, a long hole 62 that is extended in the directions of X1 and X2 is formed in the side plate 37a of the chassis 33 and the engagement part 63 is formed as a wall part at the end of the long hole 62 in the X1 direction. As shown in FIG. 8 and FIG. 9, the engagement part 63 is slightly extended and deformed to the outside (in the left direction on FIG. 8).

As described above, in the above construction, when the operator starts to move the recording medium 32 in the direction of X1 and the slider 34 starts to move from the eject position to the predetermined installation position, the first contact 64 and the second contact 65 that construct the slider insertion detection switch 44 also move in the direction of X1 relative to the chassis 33 (the side plate 37a). The part of the first contact 64 extending outside moves in the long hole 62 formed in the side plate 37a, as shown in FIG. 8.

As shown in FIG. 9, when the slider 34 is moved to the predetermined installation position, the extended part of the first contact 64 engages the engagement part 63 and is moved in the right direction on FIG. 9. As a result, the first contact 64 comes in contact with the second contact 65, and thereby the first contact 64 and the second contact 65 are electrically connected.

It is possible to adjust the timing when the first contact 64 comes in contact with the second contact 65 by means of adjusting the position of the engagement part 63. In this embodiment, the position of the engagement part 63 is selected in such a way that the first contact 64 comes in contact with the second contact 65 at the position when the slider 34 is moved to the predetermined installation position within the chassis 33.

Therefore, it is possible to detect that the slider has reached the predetermined installation position by means of detecting that the first contact 64 and the second contact 65 are electrically connected to each other using the slider insertion detection switch 44 of the embodiment of the present invention.

As described above, in case of the slider insertion detection switch 44 of the embodiment of the present invention, because the first contact 64 and the second contact 65 that construct the switch mechanism to detect the insertion of the slider 34 are provided on the slider 34, and the engagement part 63 to operate the first contact 64 is formed on the chassis 33 (the side plate 37a) as a monoblock, it is possible to reduce the number of parts and to simplify the assembly operation compared to the case in which the slider insertion detection switch is provided separately from the chassis 33 and the slider 34.

As described above, the first contact 64 and the second contact 65 that construct the switch mechanism can be constructed by the contact members and also the engagement part 63 being formed as a monoblock when the chassis 33 is formed. Therefore, the simple and low cost slider insertion detection switch 44 to detect the position of the slider 34 can be achieved.

Next, the medium insertion detection switch 50 will be precisely explained using FIGS. 7A through 7C and FIG. 10 through FIG. 13.

As described above using FIGS. 7A through 7C, the medium insertion detection switch 50 is constructed by the first contact 53 and the second contact 54 formed on the wiring board 48. Each of the contacts 53 and 54 has a narrower shape than the shape of other medium contacts 51 on the wiring board 48. As the recording medium 32 is mounted on the slider 34, one electrode pad 43 (the electrode pad 43A) of the recording medium 32 is electrically connected to both the contacts 53 and 54. That is to say, the contacts 53 and 54 are formed on a trajectory of the electrode pad 43A which is moved together with the recording medium 32 while the recording medium 32 is being inserted.

As to the length of the contact 53 and the length of the contact 54 in the directions of X1 and X2, the length of the contact 54 is greater than the length of the contact 53. The first contact 53 is electrically connected with the electrode pad 43A when the recording medium 32 is inserted to the slider 34 and reaches a position Al of the slider 34 shown by a chain-dotted line in FIG. 7A. The second contact 54 is electrically connected with the electrode pad 43A when the recording medium 32 is inserted to the slider 34 and reaches a position A2 of the slider 34 shown by a chain-dotted line in FIG. 7A.

Next, the operation of the medium insertion detection switch 50 will be explained.

FIG. 10 shows a condition where the recording medium 32 is not yet mounted on the slider 34. In this condition, the first contact 53 is not electrically connected with the second contact 54. Therefore, the medium insertion detection switch 50 is in an open state.

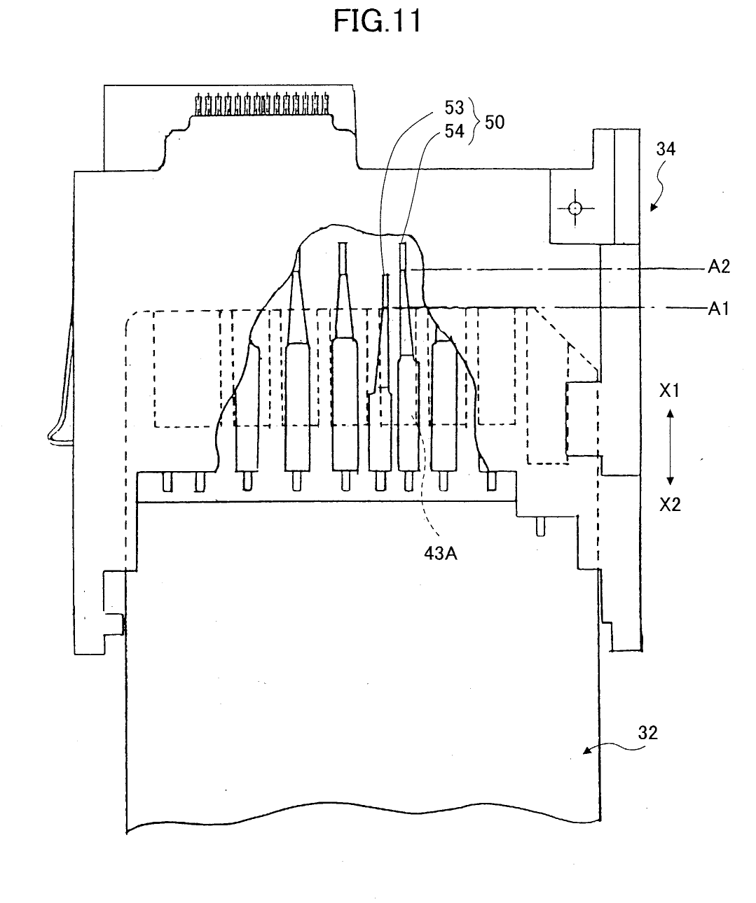

FIG. 11 shows a condition where the recording medium 32 is inserted in the direction of X1 and reaches the position A1. When the recording medium 32 is inserted and reaches the position A1, the first contact 53 is electrically connected with the electrode pad 43A, as described above. However, the second contact 54 that is longer than the first contact 53 is separated from the electrode pads 43A and therefore the second contact 54 is not electrically connected with the electrode pads 43A.

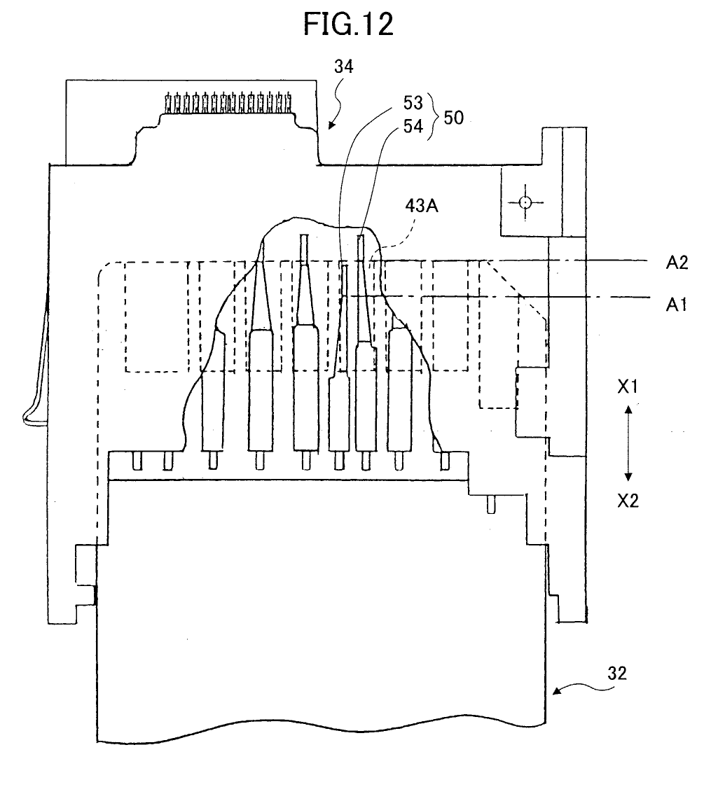

FIG. 12 shows a condition where the recording medium 32 is further inserted in the direction of X1 and reaches the position A2. When the recording medium 32 is inserted and reaches the position A2, the second contact 54 as well as the first contact 53 are electrically connected with the electrode pad 43A. That is to say, the first contact 53 and the second contact 54 are electrically connected to each other.

The position A2 is selected in such way that at the position A2, each of the electrode pads 43 formed on the recording medium 32 comes in contact with the corresponding medium connection contact 51. Therefore, when the recording medium 32 is inserted and reaches the position A2, it is possible to send a signal to or to receive a signal from the recording medium 32. The medium insertion detection switch 50 is connected to the PC and the PC stops sending a signal to or receiving a signal from the recording medium 32 until the PC receives a signal sent from the medium insertion detection switch 50.

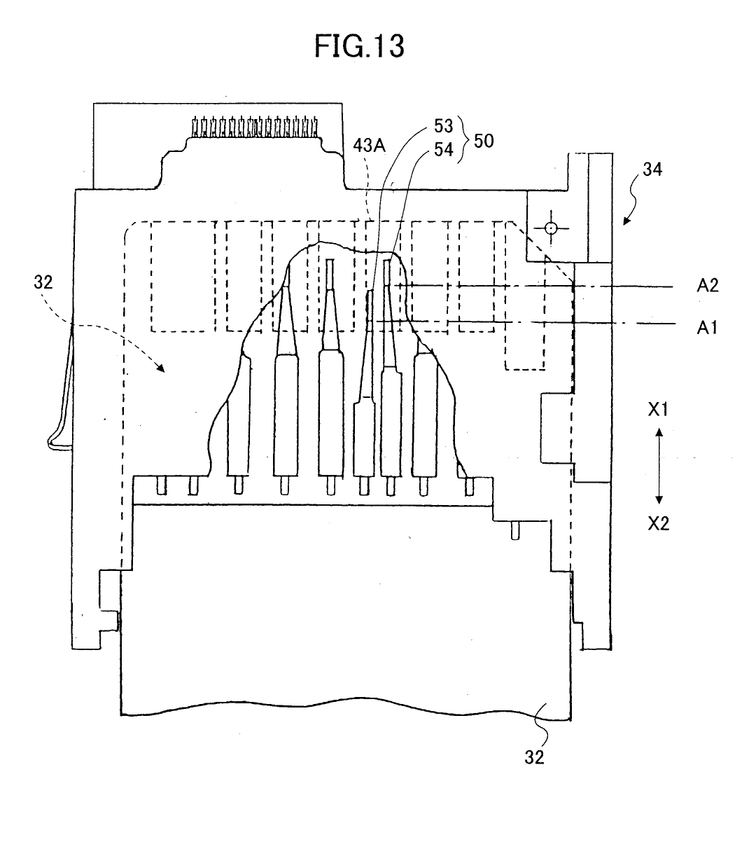

FIG. 13 shows a condition where the recording medium 32 is further inserted in the direction of X1 and reaches the predetermined installation position. In the embodiment, the position A2 at which it is possible to send a signal to or to receive a signal from the recording medium 32 is different from the predetermined installation position. However, it is also possible that the position A2 at which it is possible to send a signal to or to receive a signal from the recording medium 32 and the predetermined installation position that is determined by taking the installation strength into account are selected to be the same position. It is easy to change the insertion detection position by changing the length of the first contact 53 and the length of the second contact 54.

As shown in FIG. 12, when the recording medium 32 is mounted on the slider 34, the transmission and reception of a signal between the recording medium 32 and the PC are started. The electrode pad 43A that is used for the medium insertion detection operates as the electrode pad for a signal. Therefore, at least one of the first contact 53 or the second contact 54 that construct the medium insertion detection switch 50 can be used for a signal terminal.

This usage of at least one of the first contact 53 and the second contact 54 as the signal terminal can be achieved by a switching process controlled by a control apparatus on the PC side. For example, the control apparatus connects the first contact 53 and the second contact 54 with an insertion detection circuit until it is detected that the recording medium 32 is mounted on the slider 34, and the control apparatus connects at least one of the first contact 53 and the second contact 54 with a signal circuit when it is detected that the recording medium is properly inserted in the slider 34.

Therefore, there is no need to provide both the medium insertion detection switch 50 and the media connection contact 51 because at least one of the first contact 53 and the second contact 54 can also be used as the signal terminal. As a result, reducing the size of the slider 34 can be achieved.

As described above, when the recording medium 32 is inserted and reaches the predetermined insertion position, the first contact 53 and the second contact 54 of the medium insertion detection switch 50 are electrically connected via the electrode pad 43A. Therefore, it can be detected that the recording medium 32 is inserted and reaches the predetermined insertion position by means of detecting the electrical connection.

Because the accuracy for forming the electrode pad 43A is higher than the accuracy for forming the case of the recording medium 32, the insertion position of the recording medium 32 can be more accurately detected based on the position of the electrode pad 43A than based on the outline of the case of the recording medium 32. Furthermore, each of the contacts 53 and 54 constructing the medium insertion detection switch 50 has a self-cleaning effect because each of the contacts 53 and 54 comes in contact with the electrode pad 43A and slides on the electrode pad 43A when the insertion detection operation is performed. Therefore, contact failure between the contacts 53, 54 and the electrode pad 43A does not occur and the reliability of the insertion position detection is enhanced.

In this embodiment, the case is described where the length of the first contact 53 is different from the length of the second contact 54. It is also possible to use the first contact 53 and the second contact 54 each having the same length. However, it is more probable to conduct an accurate insertion detection if the length of the first contact 53 is different from the length of the second contact 54, because the formation error and the installation error of both of the contacts are not multiplied by each other and it is easy to detect the timing sequence of the switch.

As described in the embodiment of the present invention, the recording medium 32 is assumed to be an IC card, a memory card, and so on. However, the present invention is not limited to an IC card or a memory card as the recording medium and it is also possible to apply the present invention to disk type media such as an optical disk and a magnetic disk, tape media such as a magnetic tape, other types of media, and so on.

The present invention is not limited to the specifically disclosed embodiment, and variations and modifications may be made without departing from the scope of the present invention.

The present application is based on Japanese priority application No.2001-377807 filed on Dec. 11, 2001, Japanese priority application No.2001-377808 filed on Dec. 11, 2001, and Japanese priority application No.2001-377809 filed on Dec. 11, 2001, the entire contents of which are hereby incorporated by reference.

What is claimed is:

1. An insertion detection switch for detecting that a recording medium on which electrode pads are formed is inserted, comprising:
a first contact and a second contact that are electro-independently arranged on an insertion trajectory of one of said electrode pads of said recording medium, wherein said first contact and said second contact are electrically connected via said one of electrode pads when said recording medium is inserted to a predetermined installation position.

2. A connector apparatus having said insertion detection switch as claimed in claim 1.

3. The connector apparatus as claimed in claim 2, wherein at least one of said first contact and said second contact is used for a signal terminal.

4. A connector apparatus comprising:
a first member in which a recording medium is inserted and that has a connector to which said recording medium is connected;
a second member that movably holds said first member which first member moves to a predetermined installation position after insertion of said recording medium to said first member; and
a detection switch that detects a time when said first member reaches said predetermined installation position,
wherein said detection switch comprises:
a switch mechanism that is formed on said first member; and
an engagement part that is formed on said second member as a monoblock, engages said switch mechanism when said first member reaches said predetermined installation position and operates said switch mechanism.

5. The connector apparatus as claimed in claim 4, wherein said switch mechanism comprises:
a first contact that is formed on said first member; and
a second contact that is formed on said first member opposite to said first contact; wherein said first contact engages said engagement part and is displaced when said first member reaches said predetermined installation position, and said first contact is electrically connected with said second contact.

6. A connection apparatus comprising:
a first connector part with which a first connection member having a first shape is connected;
a second connector part with which a second connection member having a second shape different from said first shape of said first connection member is connected; and
a mold member that is molded to have said first connector part and said second connector part as a monoblock.

7. The connection apparatus as claimed in claim 6, wherein said mold member is formed to have a flat shape, and a first opening into which said first connection member is inserted is formed at one side of said mold member and a second opening into which said second connection member is inserted is formed at another side of said mold member.

8. The connection apparatus as claimed in claim 6, wherein said first connection member having said first shape is a recording medium and said second connection member having said second shape different from said first shape of said first connection member is a flexible flat cable.

9. The connection apparatus as claimed in claim 7, wherein said first connection member having said first shape is a recording medium and said second connection member having said second shape different from said first shape of said first connection member is a flexible flat cable.

10. A connector apparatus comprising said connection apparatus as claimed in claim 6.

11. A connector apparatus comprising said connection apparatus as claimed in claim 7.

12. A connector apparatus comprising said connection apparatus as claimed in claim 8.

13. A connector apparatus comprising said connection apparatus as claimed in claim 9.
